(19) United States
(12) Patent Application Publication
(10) Pub. No.: US 2019/0194891 A1
(43) Pub. Date: Jun. 27, 2019

(54) Wheeled Shovel

(71) Applicant: Jung Byung Chun, Kew Garden Hills, NY (US)

(72) Inventor: Jung Byung Chun, Kew Garden Hills, NY (US)

(21) Appl. No.: 15/855,519

(22) Filed: Dec. 27, 2017

(51) Int. Cl. E01H 5/02; A01B 1/02

(52) U.S. Cl. CPC E01H 5/02; A01B 1/02

(57) ABSTRACT

A shovel apparatus includes a shovel body, the shovel body including a left side panel portion, a right side panel portion, a bottom panel portion, and a rear panel portion, to define a shoveling area in the shovel body; and a pair of opposing wheels rotatably coupled to the left and right side panel portions of the shovel body, one to each side of the left and right side panel portions, wherein the pair of wheels are separately provided and not being connected to each other by a connecting shaft, and a handle shaft member extends in a longitudinal direction.

### FIELD OF THE INVENTION

The present invention relates to a wheeled apparatus or vehicle for moving and disposing materials. More specifically, the present invention relates to a wheeled shovel apparatus having a shovel or scoop member coupled with wheel members and configured to effectively take up, move, and throw or dispose intended materials such as snow, soil, or other matter.

### BACKGROUND OF THE INVENTION

Shovels have long been used to take up, transport and throw disposing materials such as soil and snow. Conventional shovels include a scoop or shovel for carrying the object materials, a shaft extending from the shovel, and a handle portion at the terminal end of the shaft to handle and transport such materials to a desired location.

Recently, various kinds of wheeled shovels have been proposed to carry out their intended tasks conveniently. For example, U.S. Pat. No. 5,918,921 to Samuelson proposed a wheeled snow shovel for moving snow, in which the apparatus includes a blade or shovel for carrying the snow, a shaft that extends from the blade, a wheel assembly for contacting a ground surface and which depends from a middle portion of the shaft, and a handle assembly for gripping by the user and which is provided on the rearmost end of the shaft. The wheel assembly comprises either an axle fork, an axle rotatably mounted to the axle fork, and a pair of wheels attached to the axle to which a pair of wheel are rotatably attached. The handle assembly comprises a lower transverse member for gripping by the hands of the user and extends laterally from both sides of the rearmost end of the shaft and an extender for elevating the point at which the user grips the handle assembly for users with limited bending posture.

These types of snow shovel devices suggested can be used effectively to push the snow like plowing. However, it would be quite burdensome to repeatedly lift and throw the wet and heavy snow scooped in the shovel portion, and thus, this can cause fatigue to the worker when its task involves a substantial amount wet and heavy snow or other disposing materials for removal. Moreover, as these conventional shovel apparatus includes the wheels that are separately located behind the blade (or shovel), it is difficult to control the maneuvering directions as intended, especially, when the operator is intended to drive the apparatus in round or curved way.

### SUMMARY OF THE INVENTION

Accordingly, in consideration to handle or overcome aforementioned and other shortcomings of the conventional shovel devices, the present invention is directed to a novel wheeled shovel apparatus, which can be handled and used to carry out its shoveling and transporting operations more easily and conveniently, such shoveling operations including taking up, pushing, propelling, directing, and throwing and disposing the target object matter such as snow or other materials.

According to one aspect of the invention, the wheeled shovel apparatus includes: a shovel body including a left side panel portion, a right side panel portion, a bottom panel portion, and a rear panel portion, to define a shoveling area in the shovel body; a pair of opposing wheels rotatably coupled to the left and right side panel portions of the shovel body, one to each side of the left and right side panel portions, the pair of wheels separately provided and not being connected to each other by a connecting shaft; and a handle and scraper assembly including a shaft member extending in a longitudinal direction and a scrape plate member affixed to a distal end of the shaft member. The handle and scraper assembly is detachably attachable to and from the rear panel portion via coupling configurations provided at the rear panel portion of the shovel body and the scrape plate member.

The scrape plate member preferably includes a scraping tip portion having a thickness enlarged from the scrape plate member, and the scraping tip portion can have a triangular, trapezoidal, or rectangular shape.

According to another aspect of the invention, the wheeled shovel apparatus includes: a shovel body including a left side panel portion, a right side panel portion, a bottom panel portion, and a rear panel portion, to define a shoveling area in the shovel body; a pair of opposing wheels rotatably coupled to the left and right side panel portions of the shovel body, one to each side of the left and right side panel portions, the pair of wheels separately provided and not being connected to each other by a connecting shaft; and a shaft member extending in a longitudinal direction from a rear panel portion of the shovel body. The pair of wheels are coupled to a front side of the left and right side panel portions of the shovel body, respectively, and a front lower tip area of the left and right side panel portions are located within a radial boundary (r2) of the wheels, and thus, enabling the shovel body to be freely rotatable about a center axis of the wheels, both in a driving mode and a dumping mode of the shovel apparatus, and without having the front lower tip area of the left and right side panel portions touched and interfered against the ground surface upon rotation of the shovel body.

The shaft member can include a scrape plate member affixed to a distal end of the shaft member, and the scrape plate member can be configured to be detachably attached to and from the rear panel portion of the shovel body.

### BRIEF DESCRIPTION OF THE DRAWINGS

FIG. 1 is a perspective view of a wheeled shovel apparatus in a partially disassembled state, which is constructed according to one exemplary embodiment of the present invention, including a shovel body with a pair of wheels respectively attached to left and right side panels of the shovel body, and a handle/scraper assembly having a slidable scraper plate affixed to a handle shaft, in which the scraper plate can be detachably coupled to a rear side of the shovel body.

FIG. 2 is a perspective view of a wheeled shovel apparatus according to a modified embodiment of the present invention, showing the apparatus in an assembled state, and which is similar to the apparatus of FIG. 1, however, with the shape of the handle portion modified there-from.

FIG. 2A is a perspective view of a wheeled shovel apparatus according to another embodiment of the present invention, which is similar to the apparatus of FIGS. 1 and 2, however, showing a modified handle shaft, and with the width of the shovel body enlarged therefrom to increase the intake volume of the shovel, and also with the wheels relocated toward the front side of the shovel body.

FIG. 3 is a perspective view of the handle/scraper assembly of FIG. 1, illustrating that the brush can be detachably coupled to the handle/scraper assembly.

FIG. 4 is a perspective view of the apparatus of FIG. 1, illustrating the assembling operation of the handle/scraper assembly to the shovel body of the present invention.

FIG. 5 is a schematic drawing of the apparatus of FIG. 1 or FIG. 2, showing the spatial relationships of the main components of the apparatus according to one embodiment of the present invention.

FIG. 5A is a schematic drawing of the apparatus of FIG. 2A, showing the spatial relationships of the main components of the apparatus according to another embodiment of the present invention.

FIG. 6 is a schematic drawing according to the embodiment of FIG. 2A and FIG. 5A of the present invention, showing the dumping operation for removing the materials from the shovel body of the apparatus.

### DETAILED DESCRIPTION OF THE INVENTION

With reference to the drawings, a wheeled shovel apparatus of the present invention, as well as components for the apparatus, are described and illustrated herein according to the principles of the invention. Even though the present invention is particularly described primarily in connection with a wheeled shovel apparatus for shoveling snow and related methods thereof, it is not limited thereto and may be applied to a wheeled shovel apparatus usable for other purposes, such as, for shoveling or disposing soil, dirt, debris, gravels, and other materials, while utilizing the same and similar principles and concepts disclosed in this application, or that can otherwise be derived or recognizable, without undue experiments, upon reading the full disclosure of the application.

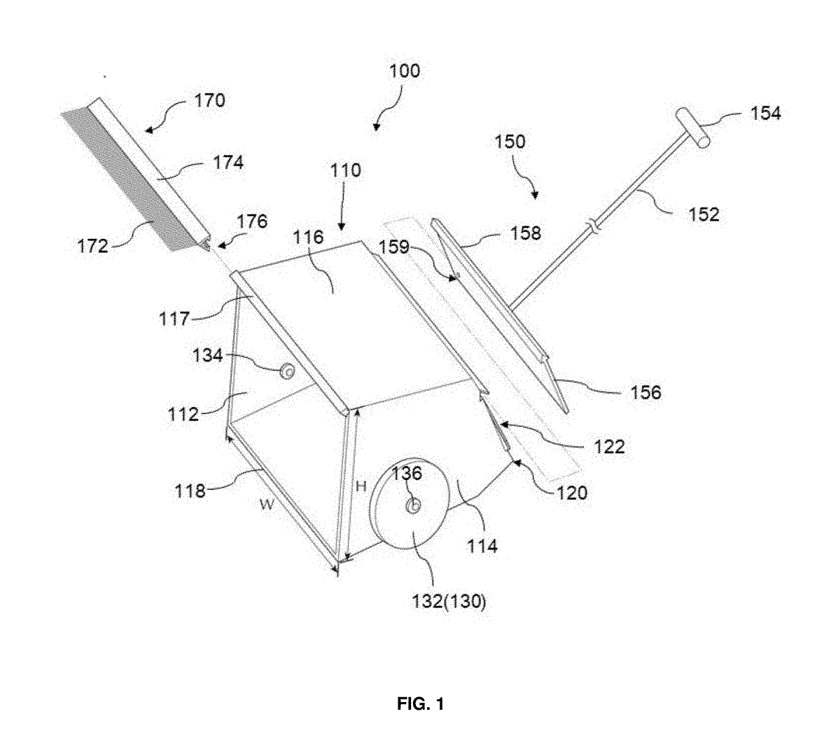

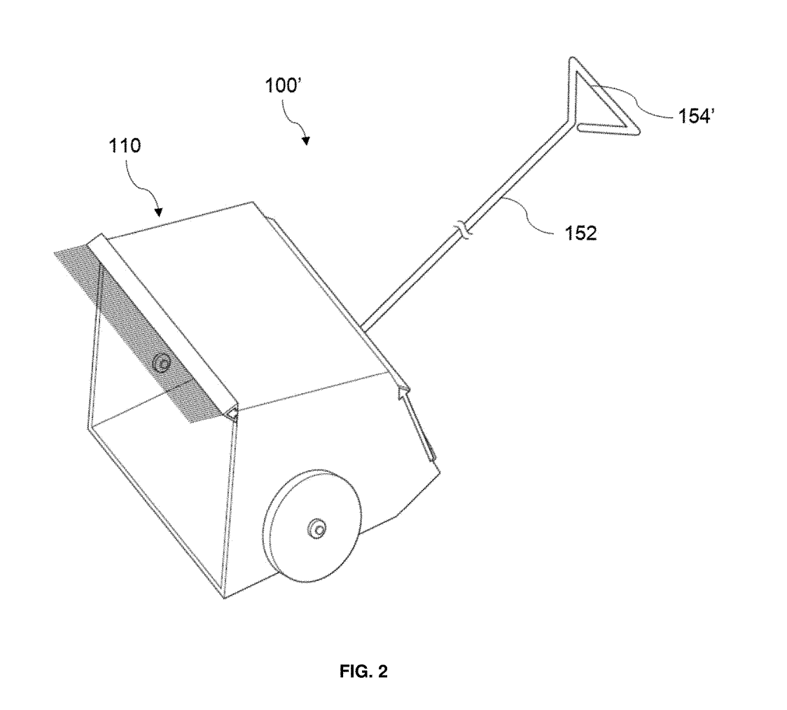

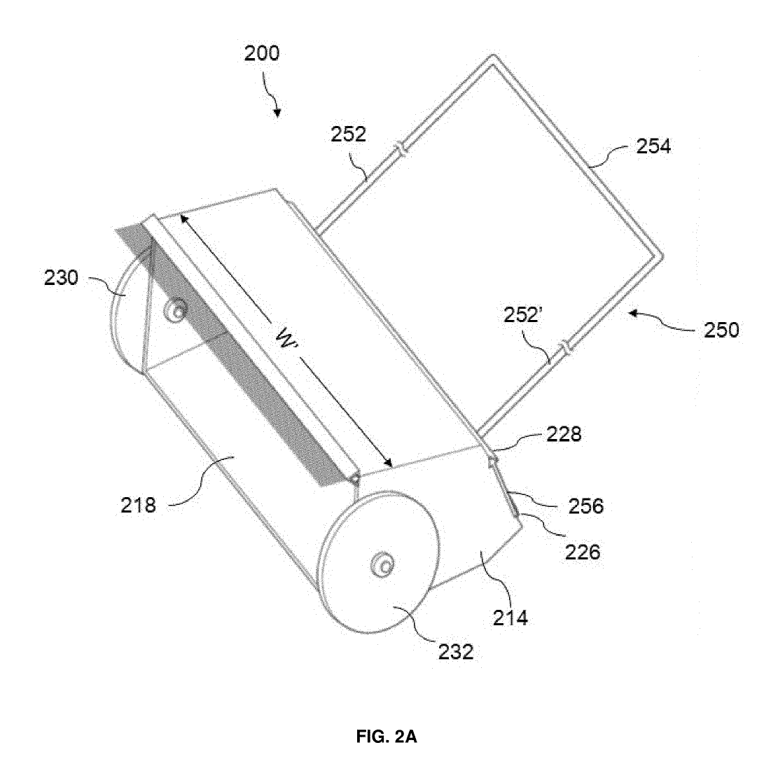

It is further noted that, unless particularly specified in the following disclosure, the present invention is not intended to be limited to the particular configurations and shapes disclosed in this application, and the shovel apparatus of the present invention (including the embodiments of FIGS. 1, 2, and 2A to be described below) can be constructed to have substantially different shapes, components, and configurations known in the shoveling apparatus art, in order to perform or enhance its picking up, transporting and disposal of various materials in an efficient and effective manner.

Referring to FIGS. 1 and 2, the shovel apparatus according to one preferred embodiment of the present invention is depicted and described herein for illustrating the principles of the invention and main components of the apparatus.

The shovel apparatus 100 (FIG. 1) or 100′ (FIG. 2) includes a shovel body 110 of exemplary appearance configured to effectively pick up and carry snow and/or other intended materials for the shoveling operation, and a pair of wheels 130 and 132 rotatably affixed to the shovel body 110, one each side of the shovel body. Here, the wheels are separately attached to the side panel members of the shovel body, respectively, and not connected to each other by a connecting shaft as in the conventional shovel apparatus. However, the present invention is not specifically limited to this structure, and the wheels may be connected by a connecting shaft as in the conventional shovel apparatus.

As shown in FIGS. 1 and 2, the shovel body 110 preferably includes left and right side panels 112 and 114, top panel 116, bottom panel 118, and rear panel 120, which together defines a width (W) and a height (H) of the shovel body. All of these panels 112-120 are formed preferably of steel, metallic or other structural materials of suitable strength for the shovel body. However, the shape and materials of the shovel body are not limited to the particular configurations as shown, and it can have various different shapes that are known in the shoveling apparatus. For example, instead of having all the panels connected in angled relation to one another as shown in the drawings, the shovel body can be shaped to have one continuously curved scoop, however, with a planar front bottom edge portion so as to effectively scrape the ground for the shoveling operation. For another example, the top panel 116 can be eliminated from the shovel body, and the remaining panels can be in a conventional shovel shape known in the art. However, it is preferable to have vertically extending side panel portions to which two opposing wheels are coupled.

Two wheels 130 and 132 are affixed to the generally vertically extending left and right side panels 112 and 114, respectively, via axle components 134 and 136 well known in the art. The axle components 134 and 136 should be configured to make the wheels freely rotatable with respect to the shovel body 110, while also mechanically supporting the entire weight of the shovel body 110 together with the intended disposing materials to be carried therein. The axle components 134 and 136 can preferably include bearings and fastening elements, such as washers, pins, bolts and nuts, as well known in the art.

The shovel apparatus as shown in FIGS. 1 and 2 further includes handle and scraper assembly 150, which includes handle shaft 152 extending in a longitudinal rearward direction, handle portion 154 (FIG. 1) or 154′ (FIG. 2) disposed at a proximal end of the handle shaft 152 and configured to be readily grasped by the user during the shoveling operation as well as the scraping operation to be discussed below, and scraper plate 156 is securely affixed at a distal end of the handle shaft 152. The scraper plate 156 is preferably in a planar plate shape and may include an enlarged tip portion with a thickness enlarged from the thickness of the plate portion. More specifically, the enlarged tip portion can be in the form of a triangular, arrow-like, trapezoidal, rectangular, or similarly shaped scraping tip portion (158) formed along the upper side edge of the plate 156. When disassembled from the shovel body 110, the handle and scraper assembly 150 can be used as a scraping tool for scraping off the snow and other disposing materials remaining in the ground or other areas such as vehicle tops.

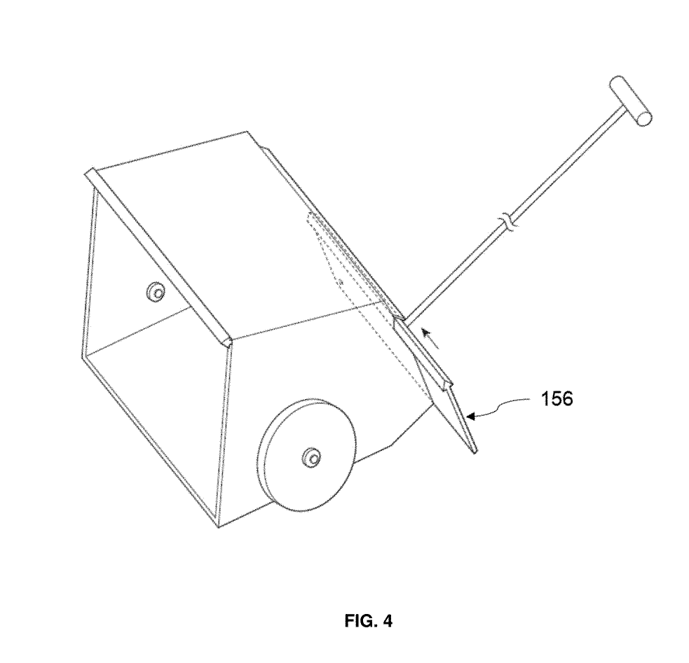

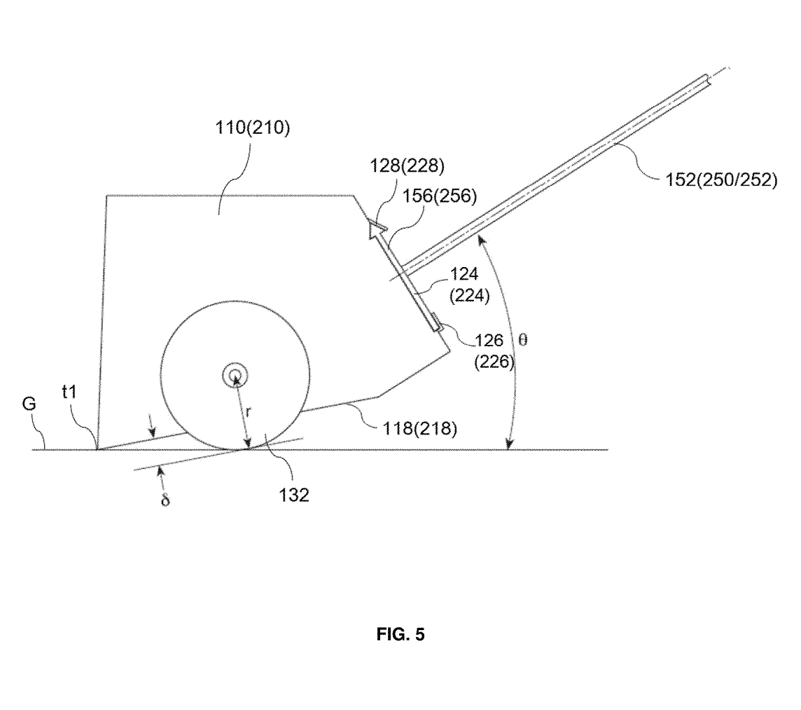

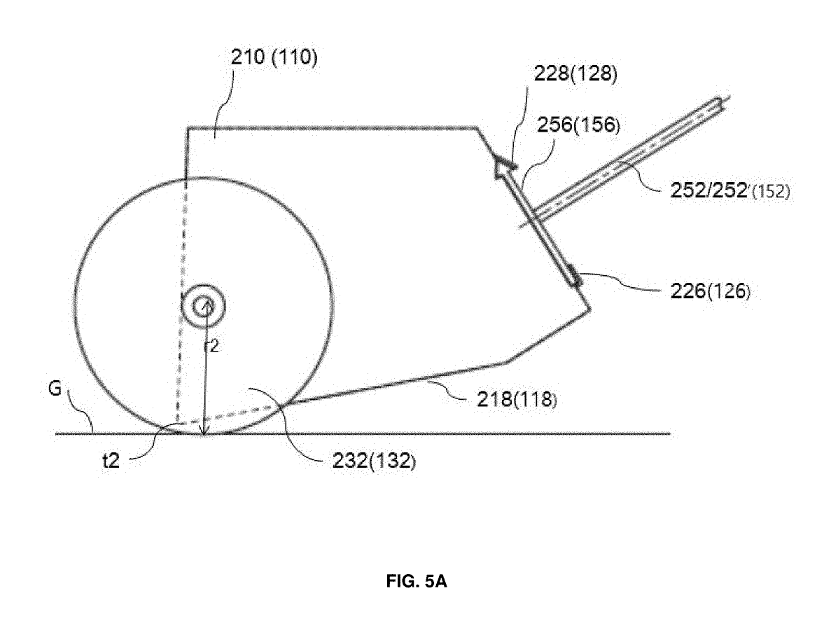

The rear panel 120 of the shovel body 110 includes a coupling configuration 122, which is preferably formed of a recessed seating area 124 at the rear panel 120, a lower coupling flange 126, and an upper coupling flange or strip 128 (as shown in FIG. 5), configured for easy and secured coupling of the scraper plate 156 to the rear side of the shovel body 110 (as shown in FIGS. 1 and 4). In order to securely fix the scraper plate 156 to the rear panel 120, a coupling hole 159 is formed at a leftmost area of the scraper plate 156, and a coupling element such as a spring-coupled locking plunger (not shown but well known in the art) is preferably provided at a corresponding location of the coupling configuration 122 of the rear panel 120. However, it is noted that the coupling configurations can be in other shapes and configurations as long as the handle and scraper assembly (e.g., 150) can securely and detachably be coupled to the rear side of the shovel body 110.

With reference to FIGS. 1, 3 and 4, the shovel body 110 preferably includes a triangular, trapezoidal, rectangular or similarly shaped tip portion 117 formed along the front side edge of the upper panel 116 of the shovel body 110, in which the triangular or trapezoidal tip portion 117 has the same or corresponding shape to the shape of the triangular or trapezoidal scraping tip portion 158. Brush 170 is optionally provided to enahnce the functions of the apparatus, and the brush 170 preferably includes brush portion 172, and coupling portion 174 with a triangular, trapezoidal, or rectangular groove 176 formed therein, and the brush 170 is detachably attached to the tip portion 117 with the aid of coupling portion 174 by slidably coupling to the tip portion 117 as illustrated in FIG. 1.

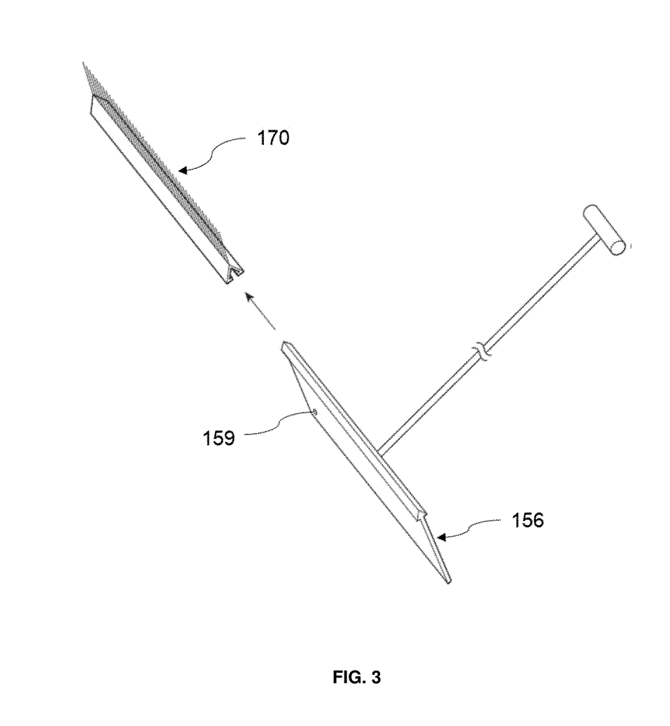

After detaching from the tip portion 117 of the upper panel 116, the brush 170 can also be coupled to the scraper plate 156 with the coupling portion 174 slidably coupled to the tip portion 158 as shown in FIG. 3, thus, enabling the user to use the handle and scraper assembly 150 as a brushing tool for brushing off the snow or other materials remaining in the ground or other areas such as vehicle tops and windshields. In order to securely fix the brush 170 to the scraper plate 156, a coupling element (e.g., a spring-coupled locking plunger or a similar element known in the art) is preferably provided at a corresponding location inside the groove of the coupling portion 174 of the brush, to which the coupling hole 159 formed at a leftmost area of the scraper plate 156 is to be detachably coupled, as noted above. In addition, the brush portion 172 of the brush 170 can be made of suitable brush or bristle with hard or medium stiffness, such as steel brush or plastic brush/bristle.

Referring now to FIG. 2A, the shovel apparatus according to another preferred embodiment of the present invention is described herein.

The shovel apparatus 200 of this embodiment is generally similar to the shovel apparatus 100 and 100′ of the previously discussed embodiment of FIGS. 1 and 2, and it similarly includes a shovel body 210 of suitable appearance configured to effectively pick up and carry intended materials (e.g., snow) therein for the shoveling operation, and a pair of wheels 230 and 232 are rotatably affixed to the shovel body 210, one each side of the shovel body, and handle and scraper assembly 250 is detachably attached to the rear side of the shovel body 210. Unless disclosed below specifically, descriptions of common/equivalent components, structures, and functions similar or corresponding to the previously discussed embodiment are omitted below for simplicity purposes, and to be referred to the above disclosure.

As shown in FIG. 2A, the wheeled shovel apparatus according to this embodiment is modified to include an enlarged shovel body 210 having an enlarged width (W′) which is greater than the width (W) of previous embodiment of FIGS. 1 and 2, in order to increase the intake volume of the shovel when the apparatus is pushed to pick up the snow or other intended materials. Also, this embodiment includes a modified handle and scraper assembly 250, in which the width of its scraper plate 256 (which is equivalent to the scraper plate 156 of FIGS. 1 and 2) is enlarged to accommodate to the enlarged shovel body 210, and also having two parallel handle shaft portions 252 and 252′ instead of a single handle shaft 152 of FIGS. 1 and 2 in order to further enhance the directional controls and the shoveling and maneuvering operability by using two hands of the operator placed toward the sides of the horizontal handle portion 254 of the handle and scraper assembly 250.

In addition, the wheels 230 and 232 have a radius r2 (see FIG. 5A) that is preferably bigger than, or similar to, the radius r (FIG. 5) of the wheels of the previous embodiment. Also, the locations of the two wheels 230 and 232 are also relocated toward the front side of the shovel body, comparing to that of previous embodiment of FIGS. 1 and 2, and this relocation can further provide additional advantages in the shoveling and maneuvering operations over the previous embodiment, which will be described herein below.

It is further noted that the relocation of the wheels is not intended to be limited only to this embodiment shown in FIG. 2A. Namely, the former embodiment, which uses the shovel body of a smaller width (W) as shown in FIGS. 1 and 2, can also be modified to have its wheel locations relocated toward the front side of the shovel body as is similar to FIG. 2A. Likewise, the present embodiment, which uses the shovel body of a larger width (W′) as shown in FIG. 2A, can also be modified to have its wheel locations relocated toward the middle or rear side of the shovel body as shown in FIGS. 1 and 2. As such, the wheels can be located at a suitable location from the front side to the rear side of the shovel body 110 or 210, depending on the particular designs of the apparatus.

Referring now to FIG. 5 and FIG. 5A, the shoveling and maneuvering operations of the shovel apparatus according to the present invention are described herein.

First, with reference to FIG. 5, operations of the shovel apparatus of the first type of the present invention are described.

The shovel apparatus of this type is configured to have its wheels 130 and 132 located at the intermediate or rear side of the shovel body 110 or 210. Here, each of the wheels has radius r, and the apparatus defines wheel clearance δ which is the clearance distance between the bottom panel 118 or 218 and the ground surface G. With this configuration, the lower front tip t1 of the apparatus contacts the ground surface G when the operator raises the handle shaft 152 (or 252 and 252′) to a ground-contact angle θ.

In operation, the operator can move the apparatus by pushing and manipulating the handle shaft 152 (or 252 and 252′) toward an intended direction. Here, the operator can freely choose the operating/driving position of the apparatus to meet its needs, namely, between a first driving position (that is, a non-touching position) in which the operator drives or propels the apparatus with the tip t1 above the ground surface G (thus, with the handle shaft 152 or 250/252 lowered than the ground contact angle θ), and a second driving position (that is, a touching position) in which he operator drives the apparatus with the tip t1 touching to the ground surface G (thus, with the handle shaft 152 or 252/252′ maintaining at the ground contact angle θ). The first driving position (that is, a non-touching position) can be selected when the operator tries to drive the apparatus idly without shoveling the materials (e.g., snow), or otherwise to preliminarily shovel the snow with the tip t1 maintaining to have a desired clearance from the ground surface, which position is selectable when the accumulated height of the snow is too high to be cleared by one shoveling drive/attempt, thus, requiring multiple or repeated shoveling operations to the snow covered space. On the other hand, the second driving position (that is, a touching position) can be selected when the operator clears the snow by one shoveling attempt.

In addition, the operator can operate the apparatus to move to a dumping position, by upwardly tilting and electing the shovel body 110 or 210 with the handle 152 or 252/252′ whiling using the ground-contacting tip t1 as a pivot/support center for the tilting movement, in order to dump down and discard the snow (or other materials) from the shovel body 110 or 210. Alternatively, the operator can throw the snow (or other materials) out from the shovel body 110 or 210 by a throwing operation using the handle 152 or 252/252′, in the manner similar to the typical throwing operation using a conventional shovel known in the art.

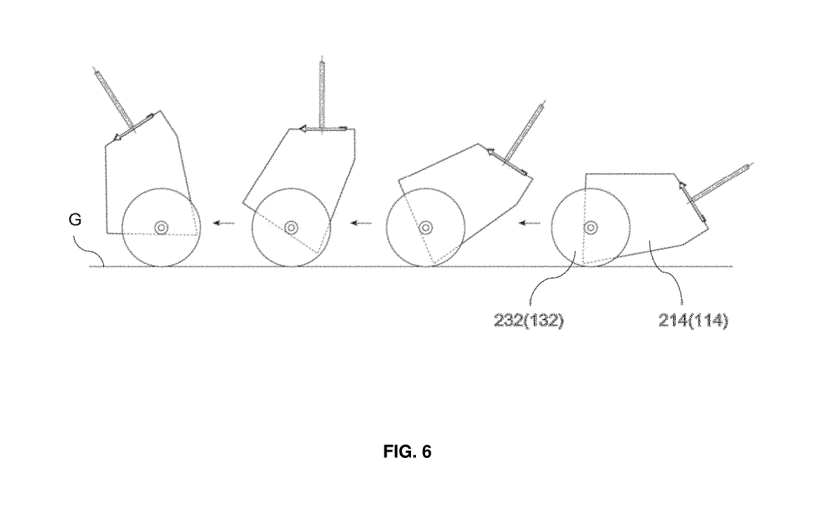

Now, with reference to FIG. 5A and FIG. 6, operations of the shovel apparatus according to the second type of the present invention are described.

The shovel apparatus of this type is configured to have its center axis of the wheels 230 and 232 (or 130 and 132) located at the front side of the shovel body 210 or 110, preferably, within twenty (20) percentage range from the front edge of the side panels 212 and 214. Here, each of the wheels has radius r2 which is preferably larger than, or otherwise similar to, the radius (r) of the first type discussed above. With this configuration, the distal lower tip t2 of the shovel body 210 or 110 is located within a radial boundary (“r2”) and preferably in the close proximity of the round wheel surface as illustrated in FIGS. 5A and 6. Accordingly, the distal/front lower tip t2 does not contact the ground surface G when the operator raises or lowers the handle shaft 152 (or 250 and 252) to any angle. Thus, this enables the shovel body 210 (or 110) to be freely rotatable about the center axis of the wheels, both in a driving mode and a dumping mode of the shovel apparatus, without having the front lower tip area t2 of the left and right side panel portions 212/214 touching and interfering against the ground surface upon rotation of the shovel body.

In operation, the operator can move the apparatus by pushing/pulling and manipulating the handle shaft 252 and 252′ (or 152) toward an intended direction. The operator can drive the apparatus to shovel and clear the snow (or other materials) by pushing the apparatus with the tip t2 positioned in close proximity of the ground surface G as shown in FIG. 6 (see the rightmost drawing thereof).

In addition, the operator can operate the apparatus to move to a dumping position, by progressively tilting and electing the shovel body 210 (or 110) with the handle 252/252′ (or 152) while propelling the apparatus with the aid of rotating wheels 230/232 (or 130/132), in order to dump and remove the snow (or other materials) from the shovel body as illustrated in FIG. 6, progressively from the right to the left side of the drawing. Alternatively, the dumping operation can also be done without propelling the apparatus since the shovel body 210 or 110 can freely be rotated about the center axis of the wheels 203 and 232 (or 130 and 132), for instance, even when the wheels become stuck and hard to rotate due to the presence of snow accumulated in the ground that are not yet cleared. As such, the dumping operations of this embodiment can be performed easily by simply raising the handle 252/252′ (or 152) and rotating the shovel body around the wheels, without causing fatigue to the operator even when its shoveling task involves a substantial amount wet and heavy snow or other heavy materials for removal.

Alternatively, the operator can also throw the snow (or other materials) out from the shovel body 210 or 110 by a throwing operation using the handle 252/252′ or 152, n the manner similar to the typical throwing operation using a conventional shovel.

Although the currently preferred embodiments of the present invention have been disclosed for illustrative purposes, those skilled in the art will appreciate that various modifications, additions and substitutions are possible, without departing from the invention in its broader aspects. The appended claims are intended to cover, therefore, such changes and modifications as fall within the true spirit and scope of the invention.

What is claimed is:

1. A shovel apparatus comprising:
a shovel body including a left side panel portion, a right side panel portion, a bottom panel portion, and a rear panel portion, to define a shoveling area in the shovel body;
a pair of opposing wheels rotatably coupled to the left and right side panel portions of the shovel body, one to each side of the left and right side panel portions, the pair of wheels separately provided and not being connected to each other by a connecting shaft; and
a handle and scraper assembly including a shaft member extending in a longitudinal direction and a scrape plate member affixed to a distal end of the shaft member,
wherein the handle and scraper assembly is detachably attachable to and from the rear panel portion via coupling configurations provided at the rear panel portion of the shovel body and the scrape plate member.

2. The shovel apparatus of claim 1, wherein the scrape plate member includes a scraping tip portion having a thickness enlarged from the scrape plate member.

3. The shovel apparatus of claim 2, wherein the scraping tip portion has a triangular, trapezoidal, or rectangular shape.

4. The shovel apparatus of claim 2, wherein the shovel body further includes a top panel portion, and the top panel portion having a tip portion with a thickness enlarged from the top panel portion.

5. The shovel apparatus of claim 4, further including a brush, and wherein the brush has a brush portion and a coupling portion, the coupling portion including a groove portion having a shape corresponding to the shape of the tip portion of the top panel portion, and wherein the brush is detachably attachable to both the tip portion of the top panel portion and the scraping tip portion of the scrape plate member.

6. The shovel apparatus of claim 5, wherein each of the tip portion of the top panel portion and the groove portion of the brush coupling portion has a triangular, trapezoidal, or rectangular shape.

7. The shovel apparatus of claim 1, wherein the coupling configurations include a coupling hole formed in the scrape plate member, the coupling hole being configured to couple with a corresponding coupling element formed in the rear panel portion of the shovel body.

8. The shovel apparatus of claim 1, wherein the pair of wheels are coupled to a front side of the left and right side panel portions of the shovel body, respectively, and a front lower tip area of the left and right side panel portions are located within a radial boundary (r2) of the wheels, and enabling the shovel body to be freely rotatable about a center axis of the wheels, both in a driving mode and a dumping mode of the shovel apparatus, and without having the front lower tip area of the left and right side panel portions touched and interfered against the ground surface upon rotation of the shovel body.

9. The shovel apparatus of claim 1, wherein the shaft member of the handle and scraper assembly has a single shaft and a handle portion is fixed to a proximal area of the single shaft.

10. The shovel apparatus of claim 1, wherein the shaft member of the handle and scraper assembly is formed of two parallel shafts and a horizontal handle portion connecting the two shafts.

11. A shovel apparatus comprising:
a shovel body including a left side panel portion, a right side panel portion, a bottom panel portion, and a rear panel portion, to define a shoveling area in the shovel body;
a pair of opposing wheels rotatably coupled to the left and right side panel portions of the shovel body, one to each side of the left and right side panel portions, the pair of wheels separately provided and not being connected to each other by a connecting shaft; and
a shaft member extending in a longitudinal direction from a rear panel portion of the shovel body,
wherein the pair of wheels are coupled to a front side of the left and right side panel portions of the shovel body, respectively, and a front lower tip area of the left and right side panel portions are located within a radial boundary (r2) of the wheels, and enabling the shovel body to be freely rotatable about a center axis of the wheels, both in a driving mode and a dumping mode of the shovel apparatus, and without having the front lower tip area of the left and right side panel portions touched and interfered against the ground surface upon rotation of the shovel body.

12. The shovel apparatus of claim 11, wherein the shaft member includes a scrape plate member affixed to a distal end of the shaft member, and the scrape plate member is configured to be detachably attached to and from the rear panel portion of the shovel body.

13. The shovel apparatus of claim 12, wherein the scrape plate member is configured to be detachably attached to and from the rear panel portion via coupling configurations provided at the rear panel portion of the shovel body and the scrape plate member.

14. The shovel apparatus of claim 13, wherein the coupling configurations include a coupling hole formed in the scrape plate member, the coupling hole being configured to couple with a corresponding coupling element formed in the rear panel portion of the shovel body.
